(19) United States
(12) Patent Application Publication
(10) Pub. No.: US 2024/0035672 A1
(43) Pub. Date: Feb. 1, 2024

(54) COOKING SYSTEM AND METHOD FOR INSTALLING A COOKING SYSTEM

(71) Applicant: BSH Hausgeräte GmbH, Munich (DE)

(72) Inventors: Beatriz Arenas Jimenez, La Muela (ES); Noelia Borque Marquina, Zaragoza (ES); Diana Lascorz Pascual, Zaragoza (ES); Damaso Martin Gomez, Zaragoza (ES); Pilar Perez Cabeza, Zaragoza (ES); Fernando Sanz Serrano, Calamocha (Teruel) (ES); María Valencia Betran, Zaragoza (ES); Francisco Villuendas Lopez, Zaragoza (ES)

(21) Appl. No.: 18/265,707

(22) PCT Filed: Nov. 18, 2021
(86) PCT No.: PCT/EP2021/082101

§ 371 Date: Jun. 7, 2023

(30) Foreign Application Priority Data
Dec. 11, 2020 (EP) 20383085.6

(51) Int. Cl. F24C 15/34; H05B 6/12

(52) U.S. Cl. CPC F24C 15/34; H05B 6/1209

(57) ABSTRACT

A cooking system, in particular an induction cooking system, includes a mounting plate, and a thermal distribution unit designed to distribute heat and including a first region having a first thermal resistance to the mounting plate, and a second region having a second thermal resistance to the mounting plate, with the second thermal resistance substantially deviating from the first thermal resistance.

The invention relates to a cooking system according to the preamble of claim 1 and a method for installing a cooking system according to the preamble of claim 14.

A cooking system having a mounting plate which is provided for mounting an item of cookware in a mounting region for the heating thereof, and having a temperature compensation unit which is provided to reduce a temperature gradient of the mounting plate between the mounting region and a region surrounding the mounting region, is already known from the prior art.

The object of the invention, in particular but not limited thereto, is to provide a generic cooking system with improved properties regarding a construction, in particular regarding a heat distribution. The object is achieved according to the invention by the features of claims 1 and 14, while advantageous embodiments and developments of the invention can be found in the dependent claims.

The invention is based on a cooking system, in particular an induction cooking system, comprising at least one mounting plate and comprising at least one thermal distribution unit which is provided for distributing heat and which has at least one first region having a first thermal resistance to the mounting plate.

It is proposed that the thermal distribution unit has at least one second region having a second thermal resistance to the mounting plate, the second thermal resistance substantially deviating from the first thermal resistance.

Improved properties of the cooking system regarding a thermal distribution can be achieved by means of such an embodiment. In particular, a thermal load on the mounting plate of the cooking system can be reduced. In particular, by means of such an embodiment heat can be conducted to those regions of the mounting plate which are subjected to particularly high mechanical stresses due to temperature differences. In particular, thermal and/or mechanical stresses on the mounting plate of the cooking system can be reduced thereby. Moreover, a service life of the mounting plate can be extended thereby. In particular, it is possible to prevent a cracking and/or rupture of the mounting plate due to thermal and/or mechanical stresses in the mounting plate. Moreover, in the case of a cracking and/or rupture of the mounting plate due to thermal and/or mechanical stresses, it is possible to prevent the mounting plate from splintering into a plurality of individual parts. In particular, the mounting plate can be held together by means of such an embodiment of the thermal distribution unit, even in the event of the mounting plate cracking and/or rupturing. In particular, a risk of injury due to potentially produced fragments of the mounting plate can be reduced thereby. Moreover, a temperature difference relative to the entire mounting plate, which causes mechanical stresses, can be advantageously reduced by means of an embodiment according to the present invention.

The cooking system can be configured at least as a part, in particular as a subassembly, of a cooktop, in particular an induction cooktop, wherein in particular accessory units for the cooktop can also be encompassed by the cooking system, such as for example a sensor unit for the external measurement of a temperature of an item of cookware and/or a food to be cooked. For example, the cooking system could have at least one cooktop object which could, in particular, be a subassembly of a cooktop. The cooktop object could be, for example, at least one control unit and/or at least one user interface and/or at least one housing unit and/or at least one heating unit and/or at least one extractor fan unit and/or at least one heating unit control electronics. It might also be conceivable that the cooking system has at least one cooktop. It might be conceivable that the mounting plate could be configured as a cooktop plate of the cooktop.

A “mounting plate” is intended to be understood to mean, in particular, a plate-like unit which in at least one operating state is provided for mounting at least one item of cookware and/or for positioning at least one food to be cooked, for the purpose of heating. The mounting plate could be configured, for example, as a countertop or as a partial region of at least one countertop, in particular of at least one kitchen countertop. Alternatively or additionally, the mounting plate could be configured as the cooktop plate. The mounting plate which is configured as the cooktop plate could form, in particular, at least a part of the cooktop external housing and form at least to a large extent the cooktop external housing, in particular together with at least one external housing unit, to which the mounting plate configured as the cooktop plate could be connected, in particular, in at least one mounted state. The mounting plate could be made, for example, at least to a large extent of glass and/or glass ceramic and/or Neolith and/or Dekton and/or wood and/or marble and/or stone, in particular natural stone, and/or laminate and/or metal and/or plastic and/or ceramic.

In particular, the cooking system has at least one heating unit, in particular induction heating unit, which is arranged below the mounting plate, and preferably a plurality of heating units, in particular induction heating units, which are arranged below the mounting plate. The thermal distribution unit is provided to distribute waste heat, which is supplied to the mounting plate when the item of cookware is heated by the heating unit, in particular by the induction heating unit, and/or by the item of cookware, in particular relative to the mounting plate. In particular, the thermal distribution unit reduces a temperature gradient between the first region and at least one further region of the mounting plate. Advantageously, the thermal distribution unit reduces the temperature gradient in a manner which goes beyond a reduction implemented by at least one material of the mounting plate.

In particular, the first thermal resistance of the first region of the thermal distribution unit to the mounting plate, for example, is at least 100%, advantageously at least 200%, particularly advantageously at least 500%, preferably at least 1000% and particularly preferably at least 3000% greater than the second thermal resistance of the second region of the thermal distribution unit to the mounting plate.

In the present application, enumerations such as for example “first”, “second” and “further” which are placed before certain terms, merely serve for a differentiation between objects and/or an assignment between objects relative to one another and do not imply an existing total number and/or ranking of the objects. In particular, a “second object” or a “further object” does not necessarily imply the presence of a “first object”.

“Provided” is intended to be understood to mean specifically designed and/or equipped. An object being provided for a specific function is intended to be understood to mean that the object fulfills and/or performs this specific function in at least one use state and/or operating state.

It is further proposed that the first region of the thermal distribution unit is provided to absorb heat from at least one heating zone, in particular from at least one induction heating zone, of the mounting plate. In particular, a heating zone, in particular an induction heating zone, is a region, in particular a volume, preferably a surface which is provided to receive an object to be heated, in particular an item of cookware and/or food to be cooked. In particular, the heating zone, in particular the induction heating zone, is heated in an operating state by the heating unit, in particular by the induction heating unit, so that the heating unit, in particular the induction heating unit, discharges at least 50%, in particular at least 70%, advantageously at least 80%, preferably at least 90% of a heating power of the heating unit, in particular the induction heating unit, into the heating zone. In particular, the cooking appliance apparatus has at least one heating zone and preferably a plurality of heating zones, in particular induction heating zones, which in each case are provided, in particular, for operating items of cookware, and which in at least one operating state are defined by the at least one heating unit, in particular induction heating unit. Preferably, the at least one induction heating zone is configured to be unchangeable regarding its position relative to the cooking system, in particular relative to the mounting plate. In particular, a thermal and/or structural behavior of the mounting plate can be improved by means of such an embodiment, in particular in the region of the heating zone and/or in a region adjoining the heating zone. In particular, a durable and/or cost-efficient embodiment of the mounting plate can be implemented thereby. In particular, stresses, in particular thermal stresses, in particular mechanical stresses, generated by heat on the mounting plate can be reduced and advantageously minimized by means of such an embodiment.

It is further proposed that the first region of the thermal distribution unit is thermally conductively connected to the mounting plate, in particular with a thermal resistance of at most 0.5 K/W, advantageously at most 0.25 K/W, particularly advantageously at most 0.1 K/W, preferably at most 0.07 K/W and particularly preferably at most 0.06 K/W. A particularly advantageous heat transfer from the mounting plate to the first region of the thermal distribution unit can be ensured thereby.

It is further proposed that the second region is at least substantially thermally insulated from the mounting plate. In particular, the second thermal resistance between the second region of the thermal distribution unit and the mounting plate is substantially greater relative to the first thermal resistance between the first region of the thermal distribution unit and the mounting plate. For example, a second thermal resistance between the second region of the thermal distribution unit and the mounting plate in a mounted state could correspond to at least double the value of the first thermal resistance, advantageously at least five times the value of the first thermal resistance, particularly advantageously at least ten times the value of the first thermal resistance, preferably at least fifteen times the value of the first thermal resistance and particularly preferably at least thirty times the value of the first thermal resistance. Advantageously, the second region of the thermal distribution unit has a thermal resistance to the mounting plate of, in particular, at least 0.5 K/W, advantageously at least 0.75 K/W, particularly advantageously at least 1 K/W, preferably at least 1.5 K/W and particularly preferably at least 2 K/W. In particular, a heat transfer from the second region of the thermal distribution unit to the mounting plate can be prevented thereby. In particular, it can be ensured thereby that the second region of the thermal distribution unit can transfer heat from the first region of the thermal distribution unit to at least one further region without a substantial proportion of this heat being lost.

It is further proposed that at least one thermal insulation medium is arranged between the second region of the thermal distribution unit and the mounting plate. It might be conceivable that air serves as the thermal insulation medium. It might also be conceivable, for example, that the cooking system has at least one thermal insulation medium which is arranged between the second region of the thermal distribution unit and the mounting plate and namely, in particular, in the mounted state. For example, the thermal insulation medium of the cooking system could comprise at least one foamed plastic, such as for example expanded polystyrene and/or extruded polystyrene. Alternatively or additionally, it might be conceivable that the thermal insulation medium of the cooking system comprises at least mineral fibers and/or mineral foams. Alternatively or additionally, it might be conceivable that the thermal insulation medium of the cooking system comprises at least wood and/or other plant-based materials. However, other thermal insulation media deemed suitable to the person skilled in the art might be also conceivable. In particular, an advantageous thermal conductivity inside the second region of the thermal distribution unit can be achieved by means of such an embodiment, and in particular starting from the first region of the thermal distribution unit, in particular through the second region of the thermal distribution unit, and in particular to a further region of the thermal distribution unit, wherein in particular a heat loss in the second region of the thermal distribution unit can be advantageously prevented.

It is further proposed that the thermal distribution unit has at least one third region having a third thermal resistance to the mounting plate, the third thermal resistance at least substantially corresponding to the first thermal resistance. “At least substantially” in this context is intended to be understood to mean that a deviation from a predetermined value, in particular, deviates by less than 25%, preferably less than 10% and particularly preferably less than 5% of the predetermined value. In particular, a particularly good heat transfer from the third region of the thermal distribution unit to the mounting plate can be achieved by means of such an embodiment. In particular, it can be ensured that the third region of the thermal distribution unit can discharge heat to the mounting plate, and namely in particular in a region of the mounting plate in which in the operating state relatively low temperatures ensure high mechanical stresses. In this regard, a particularly advantageous reduction of mechanical stresses in the mounting plate can be ensured by means of such an embodiment.

It is further proposed that the third region of the thermal distribution unit is provided to discharge heat to the mounting plate. In particular, in the operating state the third region of the thermal distribution unit discharges heat to the mounting plate. In particular, in the operating state the second region of the thermal distribution unit provides the heat of the first region of the thermal distribution unit to the third region of the thermal distribution unit, in the operating state the third region of the thermal distribution unit discharging this heat to the mounting plate in order to reduce the mechanical stresses in the mounting plate. As a result, in particular, it is possible to heat regions of the mounting plate which otherwise might be subjected to high mechanical loads due to a high temperature difference relative to other regions of the mounting plate. In particular, a service life of the mounting plate can be improved thereby.

It is further proposed that the second region is arranged between the first region and the third region and namely, in particular, relative to a view perpendicular to the mounting plate of the cooking system. For example, it might be conceivable that the first region of the thermal distribution unit defines the second region of the thermal distribution units at least from one side and advantageously from at least two sides. It might also be conceivable that the third region of the thermal distribution unit defines the second region of the thermal distribution units at least from one side and advantageously from at least two sides. A particularly advantageous heat transfer from the first region of the thermal distribution unit to the second region of the thermal distribution unit is permitted thereby. In particular, an advantageous heat transfer from the second region of the thermal distribution unit to the third region of the thermal distribution unit is permitted thereby. Moreover, an advantageous heat transfer from the first region of the thermal distribution unit to the third region of the thermal distribution unit can be permitted thereby.

It is further proposed that the second region is provided to conduct heat from the first region to the third region of the thermal distribution unit. In particular, the second region of the thermal distribution unit conducts heat from the first region to the third region of the thermal distribution unit with a thermal conductivity coefficient of, for example, at least 50 W/(m·K), advantageously at least 100 W/(m·K), particularly advantageously at least 140 W/(m·K), preferably at least 200 W/(m·K) and particularly preferably at least 250 W/(m·K). If the thermal distribution unit at least in the second region consists at least to a large extent and, for example, entirely of copper, in particular a thermal conductivity coefficient of at least 350 W/(m·K) is possible. As a result, by avoiding greater heat losses, it can be achieved that heat is conducted from the first region to the third region of the thermal distribution unit. In particular, a temperature difference in the mounting plate and thus loads generated by mechanical stresses can be advantageously reduced thereby.

It is further proposed that the first region and the third region of the thermal distribution unit extend in a common plane. Preferably, a main extension plane of the first region and a main extension plane of the third region of the thermal distribution unit extend in the common plane. A “main extension plane” of a structural unit is intended to be understood to mean a plane which is parallel to a longest side surface of a smallest imaginary cuboid which only just fully encloses the structural unit and, in particular, runs through the center point of the cuboid. The common plane extends, in particular, parallel to the mounting plate below the mounting plate. As a result, in particular, it can be permitted that the first region and the third region of the thermal distribution unit have an advantageously low thermal resistance to the mounting plate. Moreover, the mechanical stresses in the mounting plate can be reduced thereby and a service life of the mounting plate improved.

It is further proposed that the second region of the thermal distribution unit extends at least to a large extent outside the common plane, in a further plane parallel to the common plane. For example, the second region of the thermal distribution unit could be pushed out of the common plane by at least one pressure forming procedure. Alternatively or additionally, it might be conceivable that the second region of the thermal distribution unit and, in particular, a material thickness of the thermal distribution unit in the second region is machined such that the main extension plane of the second region of the thermal distribution unit extends outside the common plane, in the further plane parallel to the common plane. Alternatively or additionally, it might be conceivable that the thermal distribution unit in the first region and in the third region comprises at least one heat transfer element which, in particular, in the first region and in the third region is connected, in particular, by a material connection or at least by a positive connection to the thermal distribution unit, and ensures that the main extension plane of the first region and the third region extends outside the common plane. As a result, in particular, a relatively high thermal resistance can be provided between the second region of the thermal distribution unit and the mounting plate. In particular, a low-loss thermal conduction from the first region of the thermal distribution unit to the third region of the thermal distribution unit can be achieved thereby.

It is further proposed that the cooking system has at least one heat transfer element which connects the first region and, in particular, the third region of the thermal distribution unit to the mounting plate. In particular, the heat transfer element establishes a contact between the thermal distribution unit and namely, in particular, between the first region and/or the third region of the thermal distribution unit and the mounting plate. Preferably, the heat transfer element compensates for any unevenness, in particular surface unevenness, of the thermal distribution unit and/or the mounting plate in order to establish, in particular, a thermal contact between the thermal distribution unit and the mounting plate which is preferably free of a fluid phase, and namely preferably in the first region and/or in the third region of the thermal distribution unit. A particularly advantageous heat transfer between the mounting plate and the thermal distribution unit can be achieved, in particular, by means of such an embodiment. In particular, thermal stresses and/or mechanical stresses generated by heat on the mounting plate can be advantageously reduced by means of such an embodiment. Moreover, a service life of the mounting plate can be extended by means of such an embodiment, which in particular can further increase customer satisfaction.

It is further proposed that the heat transfer element fixes the thermal distribution unit to the mounting plate. It might be conceivable that the heat transfer element comprises at least one thermally conductive silicone, which fixes the thermal distribution unit to the mounting plate. It might also be conceivable that the heat transfer element entirely consists of thermally conductive silicone, which fixes the thermal distribution unit to the mounting plate. In particular, the heat transfer element is configured as a thin-walled thermally conductive layer which is provided, for example, to bond the thermal distribution unit to the mounting plate. In particular, the heat transfer element is arranged in a region, in particular in a volume between the thermal distribution unit and the mounting plate. In particular, the heat transfer element has a thermal conductivity of, for example, at least 1 W/(m·K), advantageously at least 2 W/(m·K), particularly advantageously at least 10 W/(m·K), preferably at least 50 W/(m·K) and particularly preferably at least 350 W/(m·K). Preferably, the heat transfer element is configured as a thermally conductive adhesive tape with a high material thickness. For example, the heat transfer element could have a material thickness of at least 0.2 mm, advantageously at least 0.3 mm, particularly advantageously at least 0.5 mm, preferably at least 0.6 mm and particularly preferably at least 1 mm. Alternatively, it might be conceivable that the heat transfer element is configured as a thermally conductive adhesive tape with a low material thickness and namely, in particular, when the second region of the thermal distribution unit is machined in the aforementioned manner and/or treated by means of pressure forming. In particular, a material thickness of the thermally conductive adhesive tape, for example, could be less than 0.3 mm, advantageously less than 0.2 mm, preferably less than 0.1 mm and particularly preferably less than 0.075 mm. In particular, the heat transfer element is configured as a double-sided aluminum adhesive tape and/or as a double-sided copper adhesive tape. It can be achieved by means of such an embodiment that the heat transfer element undertakes both the fixing between the thermal distribution unit and the mounting plate and the creation of an advantageous thermal contact. As a result, it is possible to dispense with additional components and namely, in particular, additional components for the fixing between the thermal distribution unit and the mounting plate. A cost efficiency can also be further improved thereby. Moreover, a particularly advantageous heat transfer between the mounting plate and the thermal distribution unit can be achieved, in particular, by means of such an embodiment. In particular, thermal stresses and/or mechanical stresses generated by heat on the mounting plate can be advantageously reduced by means of such an embodiment. Moreover, a service life of the mounting plate can be extended by means of such an embodiment, which, in particular, can further increase customer satisfaction.

The invention further relates to a method for installing a cooking system, in particular an induction cooking system, comprising at least one mounting plate and comprising at least one thermal distribution unit which is provided for distributing heat and which has at least one first region which is connected to the mounting plate and which has a first thermal resistance. It is proposed that thermal distribution unit has at least one second region which is arranged on the mounting plate and which has a second thermal resistance which substantially deviates from the first thermal resistance. As a result, improved properties regarding heat distribution can be achieved.

The cooking system and the method for installing a cooking system are not intended to be limited herein to the above-described use and embodiment. In particular, the cooking system and the method for installing a cooking system can have a number of individual elements, components and units which differs from a number mentioned herein in order to fulfill a mode of operation described herein.

Further advantages emerge from the following description of the drawing. Three exemplary embodiments of the invention are shown in the drawing. The drawing, the description and the claims contain numerous features in combination. The person skilled in the art will also expediently consider the features individually and combine them to form further meaningful combinations.

In the drawing:

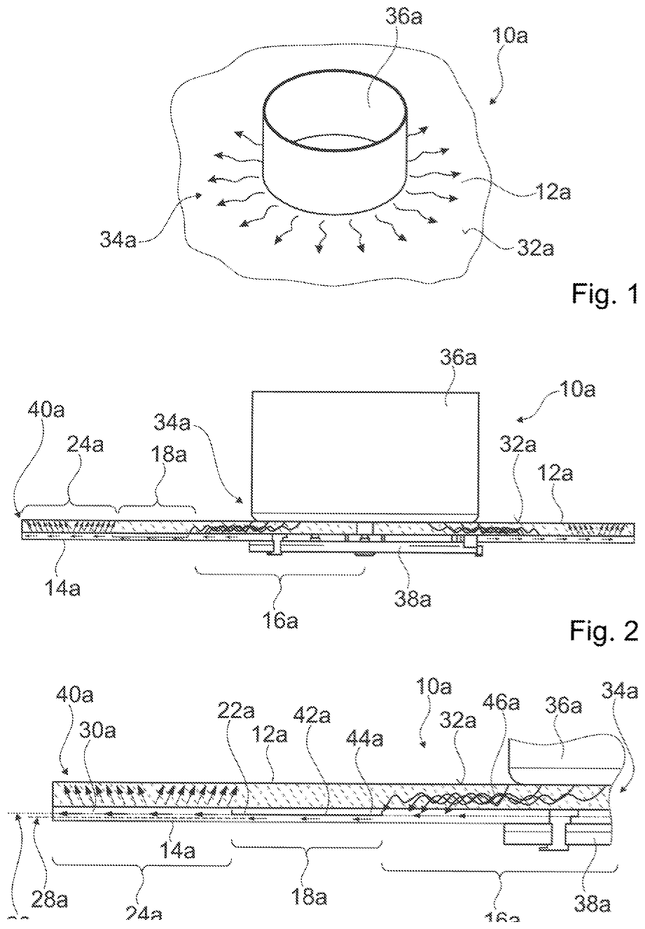

FIG. 1 shows a cooking system which is configured as an induction cooking system with a mounting plate in simplified plan view,

FIG. 2 shows a part of the cooking system with a thermal distribution unit in a simplified sectional drawing,

FIG. 3 shows a part of the cooking system with a first region, a second region and a third region of the thermal distribution unit in an enlarged view of the sectional drawing,

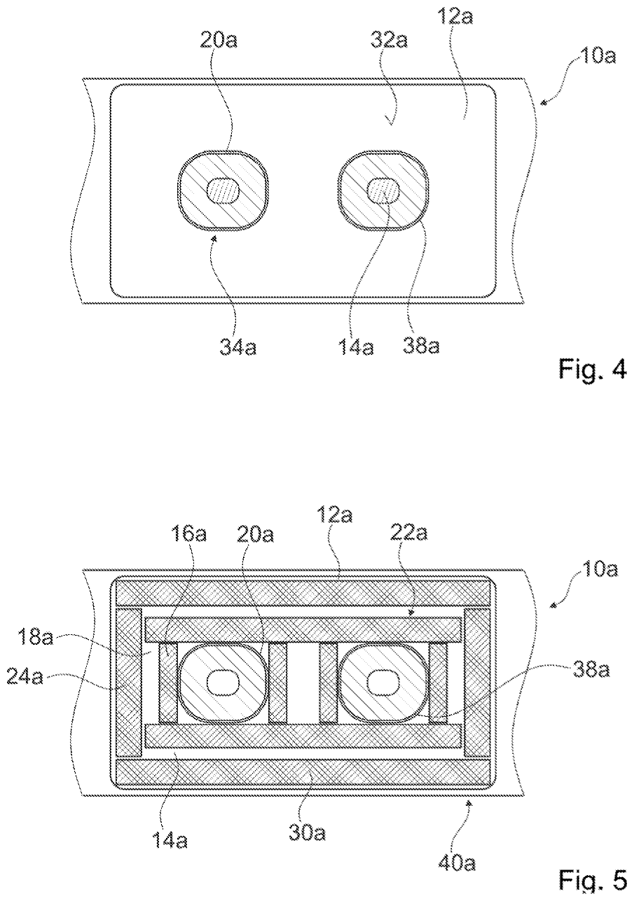

FIG. 4 shows a part of the cooking system with the mounting plate in a plan view of a visible surface of the mounting plate,

FIG. 5 shows the part of the cooking system in a partially transparent simplified drawing,

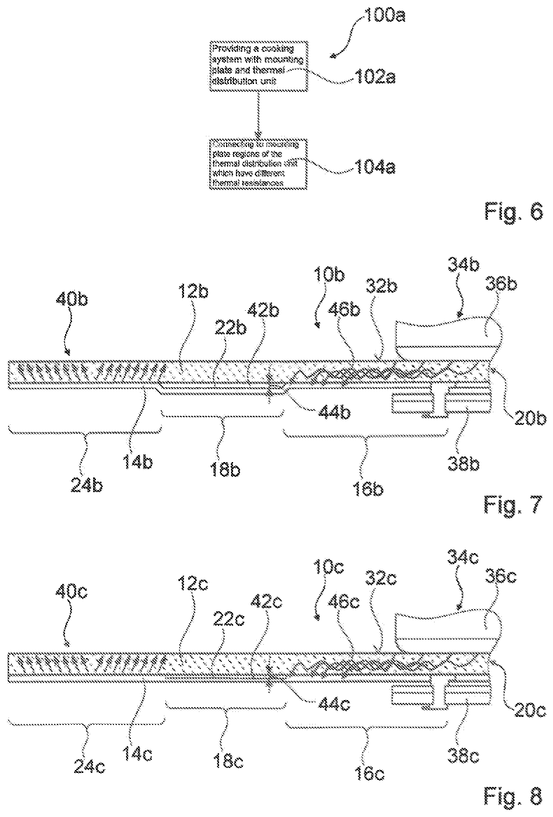

FIG. 6 shows a flow diagram of a method for installing the cooking system,

FIG. 7 shows a cooking system of a further exemplary embodiment with a mounting plate and with a thermal distribution unit in a simplified sectional drawing and

FIG. 8 shows a cooking system of a further exemplary embodiment with a mounting plate and with a thermal distribution unit in simplified sectional drawing.

In each case, only one of the objects repeatedly present is provided with a reference sign in the figures.

FIG. 1 shows a cooking system 10a which is configured as an induction cooking system. The cooking system 10a has a mounting plate 12a.

In a mounted state, the mounting plate 12a forms a visible surface 32a which in a mounted state is arranged, in particular, facing a user. The mounting plate 12a is provided for mounting an item of cookware 36a in a mounting region 34a, for the heating thereof (see FIGS. 1 and 4).

In the present exemplary embodiment, the mounting plate 12a is configured as a countertop. The mounting plate 12a, which is configured as a countertop, consists to a large extent, and in particular entirely, of a natural stone.

The cooking system 10a has at least one heating unit 38a (see FIGS. 2 and 3) which is arranged below the mounting plate 12a. In the present exemplary embodiment, the cooking system 10a has two heating units 38a. Alternatively, the cooking system 10a could have, for example, a greater number of heating units 38a, such as for example at least two, in particular at least four, advantageously at least eight, particularly advantageously at least twelve, and preferably a plurality of heating units 38a, wherein all of the heating units are arranged below the mounting plate 12a. The heating units 38a could be arranged, for example, in the form of a matrix. In the present exemplary embodiment, each of the two heating units 38a defines a heating zone 20a.

The cooking system 10a also has a thermal distribution unit 14a for distributing heat 46a. The thermal distribution unit 14a is provided to distribute heat 46a in an operating state of the cooking system 10a in which at least one item of cookware 36a is heated by means of at least one of the heating zones 20a. When the item of cookware 36a is heated by means of a heating zone 20a, which takes place in particular inductively, waste heat, for example, is produced from the heated item of cookware 36a and/or the heating unit 38a. This heat 46a, which significantly heats up the mounting plate 12a in the mounting region 34a and namely in the region of the heating zones 20a, leads to thermal stresses in the mounting plate 12a. The thermal stresses occur, in particular, due to a temperature difference in the mounting plate 12a, wherein the mounting plate 12a is significantly heated up in the mounting region 34a and namely in the region of the heating zones 20a and is relatively cold in an edge region 40a of the mounting plate 12a. The thermal distribution unit 14a is provided to compensate for this temperature difference by distributing heat 46a.

The thermal distribution unit 14a has two first regions 16a. The first region 16a has a first thermal resistance to the mounting plate 12a. This means that the first region 16a is connected to the mounting plate 12a via the first thermal resistance to the mounting plate 12a.

The first region 16a of the thermal distribution unit 14a is arranged in the vicinity of the heating zone 20a. In the present exemplary embodiment, in each case a first region 16a is connected to the mounting plate 12a, respectively in the vicinity of one of the heating zones 20a. The first region 16a is connected to the mounting plate 12a in a region of the mounting plate 12a in which the mounting plate 12a has, in particular, high temperatures. In particular, in the operating state the mounting plate 12a has the highest temperatures in the region of the heating zones 20a and, for example, also in a region adjoining the heating zones 20a.

The thermal distribution unit 14a is provided to distribute the heat 46a of the region of the heating zones 20a and, for example, also the region adjoining the heating zones 20a inside the mounting plate 12a where the mounting plate 12a has the lowest temperatures in the operating state.

The first region 16a of the thermal distribution unit 14a is provided to absorb heat 46a in each case from one heating zone 20a of the mounting plate 12a. In the present exemplary embodiment, in the operating state the first region 16a absorbs heat 46a from the region of the heating zones 20a and, for example, also from the region adjoining the heating zones 20a. In order to permit the absorption of this heat 46a, the first region 16a of the thermal distribution unit 14a is advantageously connected to the mounting plate via a low thermal resistance.

The first region of the thermal distribution unit 14a is thermally conductively connected to the mounting plate 12a with a thermal resistance of at most 0.5 K/W.

Additionally, the thermal distribution unit 14a has a second region 18a. The second region 18a has a second thermal resistance to the mounting plate 12a. In other words, the second region 18a is connected to the mounting plate 12a via the second thermal resistance to the mounting plate 12a. In the present exemplary embodiment, the second region 18a of the thermal distribution unit 14a is arranged outside a region of the heating zone 20a. The second thermal resistance substantially deviates from the first thermal resistance.

FIG. 3 shows a part of the cooking system 10a in a detail of a sectional view. A thermal insulation medium 22a is arranged between the second region 18a of the thermal distribution unit 14a and the mounting plate 12a.

In the present exemplary embodiment, air serves as the thermal insulation medium 22a which is arranged in a volume 42a between the second region 18a of the thermal distribution unit 14a and the mounting plate 12a. The volume 42a is provided by a spacing 44a between the second region 18a of the thermal distribution unit 14a and the mounting plate 12a. In the present exemplary embodiment, the spacing 44a is by way of example 2 mm.

Thus the second region 18a is at least substantially thermally insulated from the mounting plate 12a. In particular, the second thermal resistance is approximately 1.5 K/W, and namely substantially as a result of a thermal conductivity of the thermal insulation medium 22a, i.e. air. Thus the second thermal resistance deviates substantially from the first thermal resistance.

The cooking system 10a has a third region 24a of the thermal distribution unit 14a. The second region 18a is arranged between the first region 16a and the third region 24a, and namely when viewed perpendicular to the visible surface 32a of the mounting plate 12a.

The second region 18a is provided to conduct heat 46a from the first region 16a to the third region 24a of the thermal distribution unit 14a. In the exemplary configuration of the present exemplary embodiment, the second region 18a of the thermal distribution unit 14a has a thermal conductivity coefficient of approximately 236 W/(m·K), at least substantially as a result of the material of the thermal distribution unit 14a.

The third region 24a of the thermal distribution unit 14a is connected to the mounting plate 12a with a third thermal resistance to the mounting plate 12a. The third thermal resistance substantially corresponds to the first thermal resistance.

The third region 24a of the thermal distribution unit 14a is provided to discharge heat 46a to the mounting plate 12a. This is because the third region 24a of the thermal distribution unit 14a is provided to discharge heat 46a to a relatively cold region of the mounting plate 12a in order to reduce a temperature difference and thereby mechanical stresses inside the mounting plate 12a generated by the temperature difference.

In the present exemplary embodiment, the first region 16a and the third region 24a of the thermal distribution unit 14a extend in a common plane 26a and namely, in particular, relative to their respective main extension plane (see FIGS. 2 and 3).

In the present exemplary embodiment, the second region 18a of the thermal distribution unit 14a extends outside the common plane 26a. This is because the second region 18a of the thermal distribution unit 14a extends in a further plane 28a parallel to the common plane 26a. The further plane 28a is offset in parallel to the common plane 26a and namely, in particular, by the spacing 44a.

The cooking system 10a also has a heat transfer element 30a. FIGS. 5 and 6 show a part of the cooking system 10a of the present exemplary embodiment, when viewed perpendicular to the visible surface 32a of the mounting plate 12a, wherein for illustrative purposes the mounting plate 12a and the thermal distribution unit 14a are shown transparently in the region of the heat transfer element 30a in the view of FIG. 6.

The heat transfer element 30a connects the first region 16a and the third region 24a of the thermal distribution unit 14a to the mounting plate 12a. In the present exemplary embodiment, the heat transfer element 30a is a thermally conductive double-sided adhesive tape. The heat transfer element 30a fixes the thermal distribution unit 14a to the mounting plate 12a. The heat transfer element 30a also defines the spacing 44a by its material thickness.

The heat transfer element 30a has a thermal conductivity of at least 0.6 W/(m·K). The first thermal resistance and the second thermal resistance are substantially as a result of the thermal conductivity of the heat transfer element 30a, and in particular since the heat transfer element 30a compensates for any unevenness and/or prevents any potential ingress of air. In this regard, in the present exemplary embodiment the first thermal resistance and the second thermal resistance are approximately 0.06 K/W and thus substantially deviate from the third thermal resistance.

In FIG. 6 a flow diagram is shown of a method 100a for installing a cooking system 10a, in particular an induction cooking system. The method 100a comprises at least one method step 102a and at least one further method step 104a.

In the method step 102a the cooking system 10a is provided with a mounting plate 12a and with at least one thermal distribution unit 14a, wherein the thermal distribution unit 14a is provided for distributing heat and has at least one first region 16a and at least one second region 18a.

In the method step 104a the first region 16a is connected to the mounting plate 12a with a first thermal resistance and the second region 18a is connected to the mounting plate 12a with a second thermal resistance which substantially deviates from the first thermal resistance.

In FIGS. 7 and 8 two further exemplary embodiments of the invention are shown. The following descriptions are substantially limited to the differences between the exemplary embodiments, wherein relative to components, features and functions remaining the same, reference can be made to the description of the exemplary embodiments of FIGS. 1 to 6. To differentiate between the exemplary embodiments the letter a in the reference signs of the exemplary embodiment in FIGS. 1 to 6 is replaced by the letters b and c in the reference signs of the exemplary embodiments of FIGS. 7 and 8. Relative to components denoted the same, in particular relative to components having the same reference signs, in principle reference can also be made to the drawings and/or the description of the exemplary embodiment of FIGS. 1 to 6.

FIG. 7 shows a part of a further exemplary embodiment of a cooking system 10b in a sectional view which is not to scale. The cooking system 10b is configured as an induction cooking system. The cooking system 10b has a mounting plate 12b. The cooking system 10b has a plurality of heating units 38b which are arranged below the mounting plate 12b, for the sake of clarity only one thereof being shown.

The cooking system 10b also has a thermal distribution unit 14b for distributing heat 46b. The thermal distribution unit 14b is provided to distribute heat 46b in an operating state of the cooking system 10b in which at least one item of cookware 36b is heated.

The thermal distribution unit 14b has a first region 16b. The first region 16b has a first thermal resistance to the mounting plate 12b. In other words, the first region 16b is connected to the mounting plate 12b via the first thermal resistance to the mounting plate 12b.

The thermal distribution unit 14b also has a second region 18b. The second region 18b has a second thermal resistance to the mounting plate 12b. In other words, the second region 18b is connected to the mounting plate 12b via the second thermal resistance to the mounting plate 12b. In the present exemplary embodiment, the second region 18b of the thermal distribution unit 14b is arranged outside a region of the heating zone 20b. The second thermal resistance substantially deviates from the first thermal resistance.

In order to provide a second thermal resistance which deviates from the first thermal resistance, in the present exemplary embodiment a volume 42b is arranged between the second region 18b of the thermal distribution unit 14b and the mounting plate 12b. Air serves as the thermal insulation medium 22b inside the volume 42b.

The volume 42b is provided by a spacing 44b between the second region 18b of the thermal distribution unit 14b and the mounting plate 12b.

In contrast to the above exemplary embodiment, the spacing 44b is achieved by pressure forming the second region 18b of the thermal distribution unit 14b. In the present exemplary embodiment, the second region 18b of the thermal distribution unit 14b is pressed out of a common plane in which the first region 16b of the thermal distribution unit 14b and a third region 24b of the thermal distribution unit 14b are arranged.

FIG. 8 shows a part of a further exemplary embodiment of a cooking system 10c in a sectional view which is not to scale. The cooking system 10c is configured as an induction cooking system. The cooking system 10c has a mounting plate 12c. The cooking system 10c has a plurality of heating units 38c which are arranged below the mounting plate 12c, for the sake of clarity only one thereof being shown.

The cooking system 10c also has a thermal distribution unit 14c for distributing heat 46c. The thermal distribution unit 14c is provided to distribute heat 46c in an operating state of the cooking system 10c in which at least one item of cookware 36c is heated.

The thermal distribution unit 14c has a first region 16c. The first region 16c has a first thermal resistance to the mounting plate 12c. In other words, the first region 16c is connected to the mounting plate 12c via the first thermal resistance to the mounting plate 12c.

The thermal distribution unit 14c also has a second region 18c. The second region 18c has a second thermal resistance to the mounting plate 12c. In other words, the second region 18c is connected to the mounting plate 12c via the second thermal resistance to the mounting plate 12c. In the present exemplary embodiment, the second region 18c of the thermal distribution unit 14c is arranged outside a region of the heating zone 20c. The second thermal resistance substantially deviates from the first thermal resistance.

In order to provide a second thermal resistance which deviates from the first thermal resistance, in the present exemplary embodiment a volume 42c is arranged between the second region 18c of the thermal distribution unit 14c and the mounting plate 12c. Air serves as the thermal insulation medium 22c inside the volume 42c.

According to the configuration of the present exemplary embodiment, the volume 42c is milled out of the thermal distribution unit 14c.

### REFERENCE SIGNS

10 Cooking system
12 Mounting plate
14 Thermal distribution unit
16 First region
18 Second region
20 Heating zone
22 Thermal insulation medium
24 Third region
26 Common plane
28 Further plane
30 Heat transfer element
32 Visible surface
34 Mounting region
36 Item of cookware
38 Heating unit
40 Edge region
42 Volume
44 Spacing
46 Heat
100 Method
102 Method step
104 Method step

1-14. (canceled)

15. A cooking system, in particular an induction cooking system, said cooking system comprising:
a mounting plate; and
a thermal distribution unit designed to distribute heat and including a first region having a first thermal resistance to the mounting plate, and a second region having a second thermal resistance to the mounting plate, the second thermal resistance substantially deviating from the first thermal resistance.

16. The cooking system of claim 15, wherein the first region of the thermal distribution unit is designed to absorb heat from a heating zone, in particular induction heating zone, of the mounting plate.

17. The cooking system of claim 15, wherein the first region of the thermal distribution unit is thermally conductively connected to the mounting plate.

18. The cooking system of claim 15, wherein the second region is at least substantially thermally insulated from the mounting plate.

19. The cooking system of claim 15, further comprising a thermal insulation medium arranged between the second region of the thermal distribution unit and the mounting plate.

20. The cooking system of claim 15, wherein the thermal distribution unit includes a third region having a third thermal resistance to the mounting plate, the third thermal resistance at least substantially corresponding to the first thermal resistance.

21. The cooking system of claim 20, wherein the third region of the thermal distribution unit is designed to discharge heat to the mounting plate.

22. The cooking system of claim 20, wherein the second region is arranged between the first region and the third region.

23. The cooking system of claim 20, wherein the second region is designed to conduct heat from the first region to the third region of the thermal distribution unit.

24. The cooking system of claim 20, wherein the first region and the third region of the thermal distribution unit extend in a common plane.

25. The cooking system of claim 24, wherein the second region of the thermal distribution unit extends at least to a large extent outside the common plane, in a further plane parallel to the common plane.

26. The cooking system of claim 15, further comprising a heat transfer element connecting the first region of the thermal distribution unit to the mounting plate.

27. The cooking system of claim 20, further comprising a heat transfer element connecting the third region of the thermal distribution unit to the mounting plate.

28. The cooking system of claim 26, wherein the heat transfer element fixes the thermal distribution unit to the mounting plate.

29. The cooking system of claim 27, wherein the heat transfer element fixes the thermal distribution unit to the mounting plate.

30. A method for installing a cooking system, in particular an induction cooking system, with the cooking system comprising a mounting plate and a thermal distribution unit, said method comprising:
connecting a first region of the thermal distribution unit to the mounting plate, with the first region having a first thermal resistance; and
arranging a second region of the thermal distribution unit on the mounting plate, with the second region having a second thermal resistance which substantially deviates from the first thermal resistance.

31. The method of claim 30, wherein the first region of the thermal distribution unit is thermally conductively connected to the mounting plate.

32. The method of claim 30, further comprising substantially thermally insulating the second region least from the mounting plate.

33. The method of claim 30, further comprising arranging a thermal insulation medium between the second region of the thermal distribution unit and the mounting plate.

34. The method of claim 30, further comprising connecting the first region and a third region of the thermal distribution unit to the mounting plate via a heat transfer element, with the third region having a third thermal resistance which at least substantially corresponds to the first thermal resistance.
